(19) United States
(12) Patent Application Publication
(10) Pub. No.: US 2007/0203895 A1
(43) Pub. Date: Aug. 30, 2007

(54) Recursive search engine using correlative words

(76) Inventor: Hossein Eslambolchi, Los Altos Hills, CA (US)

Correspondence Address: HELLER EHRMAN LLP, 275 MIDDLEFIELD ROAD, MENLO PARK, CA, 94025-3506, US

(21) Appl. No.: 11/679,977

(22) Filed: Feb. 28, 2007

Related U.S. Application Data
(60) Provisional application No. 60/778,016, filed on Feb. 28, 2006.

(51) Int. Cl. G06F 17/30

(52) U.S. Cl. 707/3

(57) ABSTRACT

A search engine is provided that searches the internet for a word (or set of words) referred to a searched words. This first search may use a commercially available search engine. The results of the first search are used to create correlative words using unique and count procedures. Those correlative words with the highest count (correlation) are displayed first. A subset of the correlative words is inserted in the first search engine and reruns the search, This previous step is repeated recursively or sequentially until the results converge. The search converges faster if a word of high correlation is excluded or a word of low correlation is included.

### CROSS-REFERENCE TO RELATED APPLICATIONS

This application claims the benefit of U.S. Ser. No. 60/778,016, filed Feb. 28, 2006, which application is fully incorporated herein by reference.

### BACKGROUND OF THE INVENTION

1. Field of the Invention

The present invention relates generally to search engine technology such as Google and Yahoo, and more particularly to search engine technology that utilizes correlative words and phrases.

2. Description of the Related Art

Existing search engines like Google work well when searching for a topic or word that is not common and the search results are no more than few hundreds. When dealing with common words or phrases like the word ANIMALS, the search counts are in the millions.

Search engines have provided advanced search capabilities as a poor attempt to solve this problem. The problem with advanced searches is that the search rules available are too generic to be useful. The final search result count may be better than the “simple search” but still in the millions.

In addition, searching a word like ANIMALS diverges into many different topics and directions. Without assistance, the only choice the user has to converge is to “include” and “exclude” searched-words (the initial word of phrase being used in the search) randomly until something satisfactory results.

Existing search engines provide millions of results for common searches and are impossible to converge to a useful and manageable set.

### SUMMARY OF INVENTION

Accordingly, an object of the present invention is to provide a search engine that allows the user to converge search results from millions to a limited, more manageable set in a short period of time.

Another object of the present invention is to provide a search engine that is valuable for users performing searches from devices with limited real estate and bandwidth, including but not limited to PDA's, cellular hones and the like.

Yet another object of the present invention is to provide a search engine that speeds convergence through recursively limiting the scope of search.

A further object of the present invention is to provide a search ending that automatically suggests additional search words based on a correlation ratio.

Still a further object of the present invention to provide a search engine that automatically suggests additional search words based on a correlation ratio, where the higher the correlation ratio of the excluded words, the quicker the search converges, and the lower the correlation ratio of the included words, the quicker the search converges.

These and other objects of the present invention are achieved in, a search engine that searches the internet for a word (or set of words) referred to a searched words. This first search may use a commercially available search engine. The results of the first search are used to create correlative words using unique and count procedures. Those correlative words with the highest count (correlation) are displayed first. A subset of the correlative words is inserted in the first search engine and reruns the search. This previous step is repeated recursively or sequentially until the results converge. The search converges faster if a word of high correlation is excluded or a word of low correlation is included.

In one embodiment of the present invention, a search engine provides the user with a list of words or phases that appear most frequently associated with the word being searched for, removes these or words or phrases from the search, and converges the search to a smaller, more manageable set of results.

### DRAWINGS

FIG. 1 is a flowchart illustrating one embodiment of a recursive search that can be utilized with the present invention.

FIG. 2 illustrates one embodiment of how a user a searched word into a commercial search engine, and a second search is then conducted to create correlative words.

FIG. 3 illustrates one embodiment of the present invention of how correlative words are moved to searched words.

FIG. 4 illustrates one embodiment of the present invention where recursive searches converge a search count from 74 million to 11.

### DETAILED DESCRIPTION

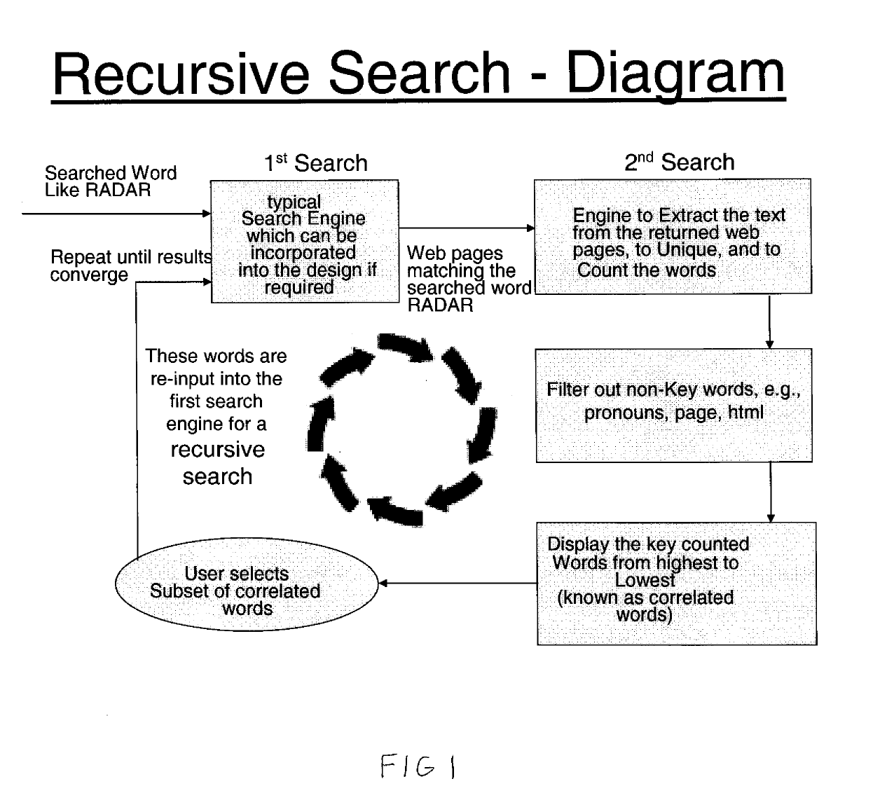

Referring now to the flow chart of FIG. 1, one embodiment of the present invention, a search engine provides the user with a list of words or phases that appear most frequently associated with the word being searched for, removes these or words or phrases from the search, and converges the search to a smaller, more manageable set of results. Correlative words and/or phrases are used to recursively converge search results. Correlative words are words that correspond to each other and are regularly used together. By way of illustration, for the word RADAR, for example, the word WEATHER appears once every two times the word RADAR appears. The word DETECTOR appears once every 20 times the word RADAR appears. If a correlation model were built, the correlation ratio of the word WEATHER to RADAR is 0.5 and DETECTOR to RADAR is 0.05.

The search engine of the present invention is not limited to the use of correlative words. It can be expanded to cover key correlative phrases. The selection of key phases allows the user to make better sense or the correlative words/phrases. Thus instead of displaying the correlated words AFRICAN and IVORY separately, the search will display the correlated phrase AFRICAN IVORY as one of the correlated-phrase.

The search engine performs two sequential search. The first search will search the internet for a word, or set of words, referred to as searched words. The first search uses typical search engine routines, such as Google, Yahoo and the like, that “uniquely selects” and “counts” the output of a typical search engine. It extracts the words from the title, header, or body (as the design requires) of the returned web pages that matches the initial searched word. The results of the first search are used to create correlative words using unique and count procedures.

The second search engine, referred herein as the “Correlative Word Search Engine” receives the “titles” and “headers” from the first search and counts the occurrences of each of the unique words returned. This is achieved by extracting all the words from the titles and headers of each webpage returned from the first search, removing the common words and pronouns, and counting the occurrences of the correlative words. The search, selecting and counting operations can be performed simultaneously. A search engine that is not restricted to perform its search, unique select and count operations sequentially. All these can be performed simultaneously.

The second search is not restricted to counting the occurrences of words in the “titles” and “headers,” it may also include the body of the web page. If searching through the body of the webpage is not restrictive (time and performance), this invention can be improved by searching through the entire content of the website instead of just searching the titles and headers.

The success of the Correlative Word Search Engine design depends on selecting the key word or phrases for counting the occurrence of the words (or phrases) that are being correlated to the searched word, as discussed hereafter.

Those correlative words with the highest count (correlation) are displayed first. A subset of the correlative words is inserted in the first search engine and reruns the search. This previous step is repeated recursively or sequentially until the results converge. The search converges faster if a word of high correlation is excluded or a word of low correlation is included.

By way of illustration, and without limitation, word “:Mercedes” the word “car” appears once for every two instances that the word Mercedes appears. The word “Luxury” appears once every ten times the word Mercedes appears. With a correlation model, the correlation of the word “car” to Mercedes is 0.5 and “Luxury” to “Mercedes is 0.1.

Using the Correlative Words concept, the search engine of the present invention takes a searched-word as input like any other search engine.The output is two sets of results: 1) the items that matched the searched-word and 2) a list of Correlative Words to the searched-word sorted from the highest to the lowest by the ratio (or count) of correlation.

The next step in the search is for the user to pick from the Correlative Words and “include” or “exclude” them into the searched-words and re-run the search. The higher the correlation ratio of the excluded word, the quicker the search will converge, and vice versa.

A new set of Correlative Words is now created based on the new searched words input. The searched words now include the original searched words, plus or minus whatever the user enter during the first recursive step. Thus if the word MERCEDES was entered during the First Search, and the second search shows that the word LUXURY appears more often associated with the word MERCEDES. Then this Search will have the following input “MERCEDES-LUXURY”

The user selects from the Correlative Words and “includes” or “excludes” them into the searched-words and re-run the search. The above step is repeated until the search converges to a limited, manageable set of search results. By way of illustration, and without limitation, if the “MERCEDES-LUXURY” search determined that the phrase “SECOND WORLD WAR” appears less often, and that the user is interested in MERCEDES as it relates to the topic, then adding the phase “SECOND WORLD WAR” will help converge the search further. Thus the search becomes: “MERCEDES-LUXURY “SECOND WORLD WAR”

The Correlative Word Search Engine can filter common words like pronouns and propositions when selecting the words being correlated. Also, the design can filter common internet words such as PAGE or HTML.

The Correlative Word Search Engine counts the number of the unique words found in the search results returned and displays the counts on the screen as numeric counts or ratios. A ratio can be simply obtained by dividing the count of the correlative word over the count of the searched word. The Correlative Word Search Engine extracts all the words from the titles and headers of all the WebPages returned, it filters the pronouns and the common words, and sorts and counts the rest of the words. The count along with the associated word are then displayed on the screen.

The correlative words are displayed in the order of highest to lowest count (or correlation). The words can be displayed in other ways to enable the user to make the proper selection. For example, the program may suggest the exclusion of the most occurring 5 words. And suggest the inclusion of the 5 least occurring 5 words. The user displays will vary depending on need and applications.

The user then selects one or many of these correlative words to include (known as +) or exclude (known as −) from the searched words. The new set of searched words is re-input through the first search engine and the search results are received and sent to the Correlative Word Search Engine again.

The Correlative Word Search Engine counts the number of the unique words found in the search results returned and displays the counts on the screen as numeric counts or ratios.

The user repeats the preceding step until the search converges to a limited, manageable number of search results. A manageable set is a set that is small enough for the user to be able to sort through within the allotted time.

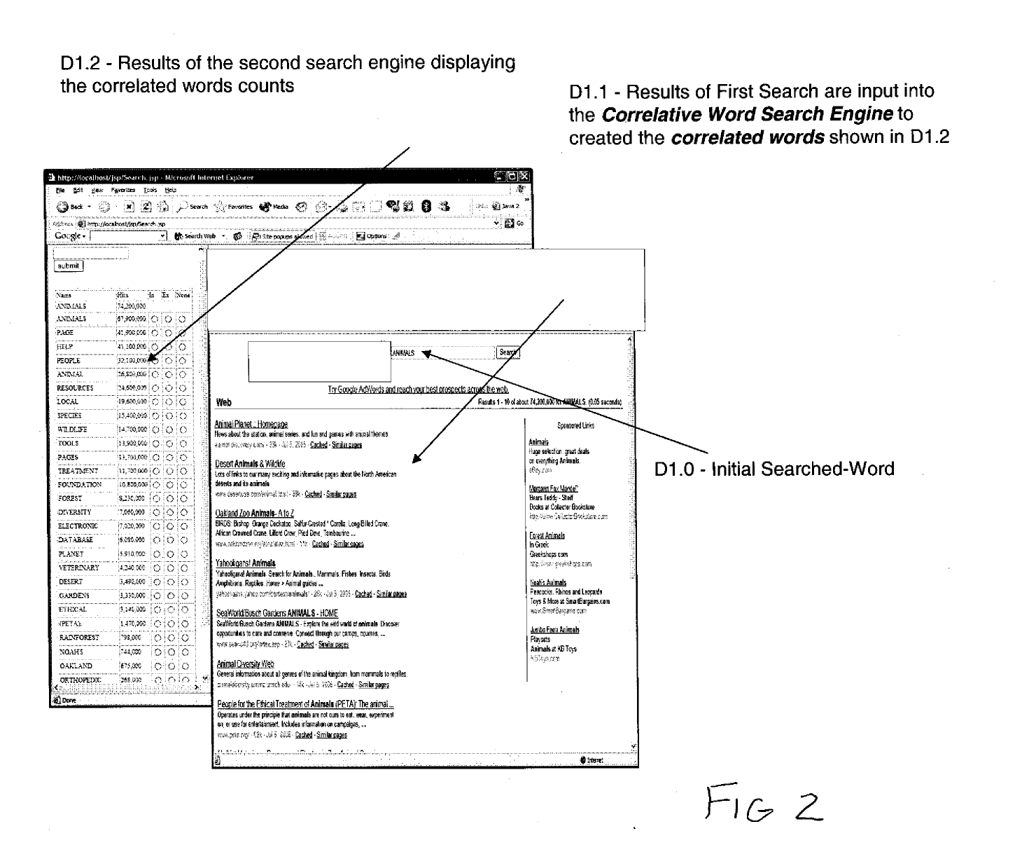

Referring to FIG. 2, the user enters a searched word [D1.0] into the search engine like Google or Yahoo and requests a search. The search engine provides the user with a list of search results [D1.1]. The second search engine receives the searched results and creates and displays the correlative words as described above and as shown in [D1.2]. The correlation value may be expressed as a count or as a ratio. The attached screens [D1.2] use a count for illustration. A ratio can be simply obtained by dividing the count of the correlative word over the count of the searched word.

Common words such as pronouns, propositions and the like, are filtered when selecting the correlative words. If this approach is not followed, the common English words will make this approach futile.

By way of illustration, and without limitation, the word ANIMALS is used as the searched-word as shown in [D1.0].

The word ANIMALS is found about 74 million times. Listed under the word ANIMALS are the words that most often accompany the word ANIMALS. These words are known as the correlative words to the word ANIMAL. These words are listed starting with the highest correlative value (or count) and ending with the lowest. The word PAGE has the highest correlation and the word ORTHOPEDIC has the lowest correlation.

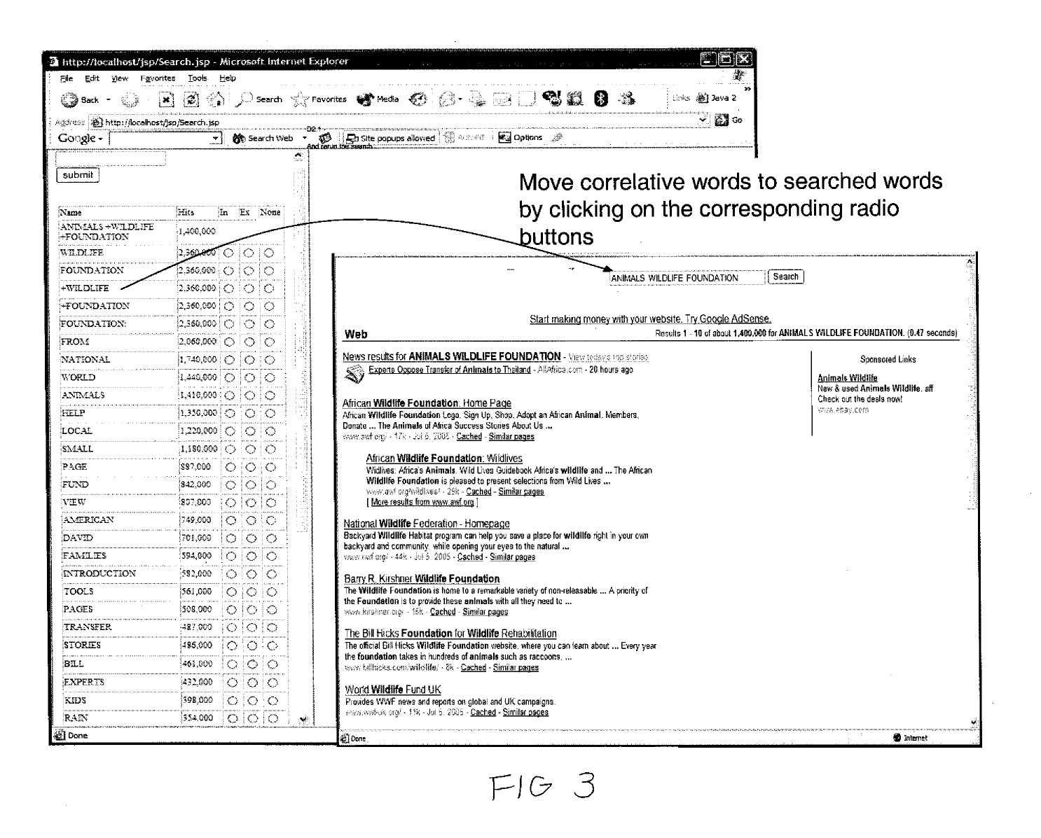

The next step is to perform a Correlative Search to generate the correlative words associated with the original search. The user will then use the correlative words as input to the generic search engine. These steps are repeated recursively until the search converges. Before performing these recursive steps, the user has to “include” or “exclude” words from the correlative words into the searched-words as shown in [D2.1]. To accomplish this, the user clicks of the radio buttons to either include or exclude the corresponding words. In the example shown below, the user decided to “include” the words WILDLIFE and FOUNDATION, and recursively run the search as shown in FIG. 3.

In this non-limiting example, the new search converged from 74 million to 1.4 million counts. A new set of correlative words is generated. These words are correlated relative to the new searched-words: ANIMAL, WILDLIFE and FOUNDATION.

The next recursive step reduces the search count to 3400. Again, a new set of correlated words is generated. This time relative to the searched-words: ANIMALS+FOUNDATION+WILDLIFE+AFRICAN-FROM-WORLD-HELP-PAGE.

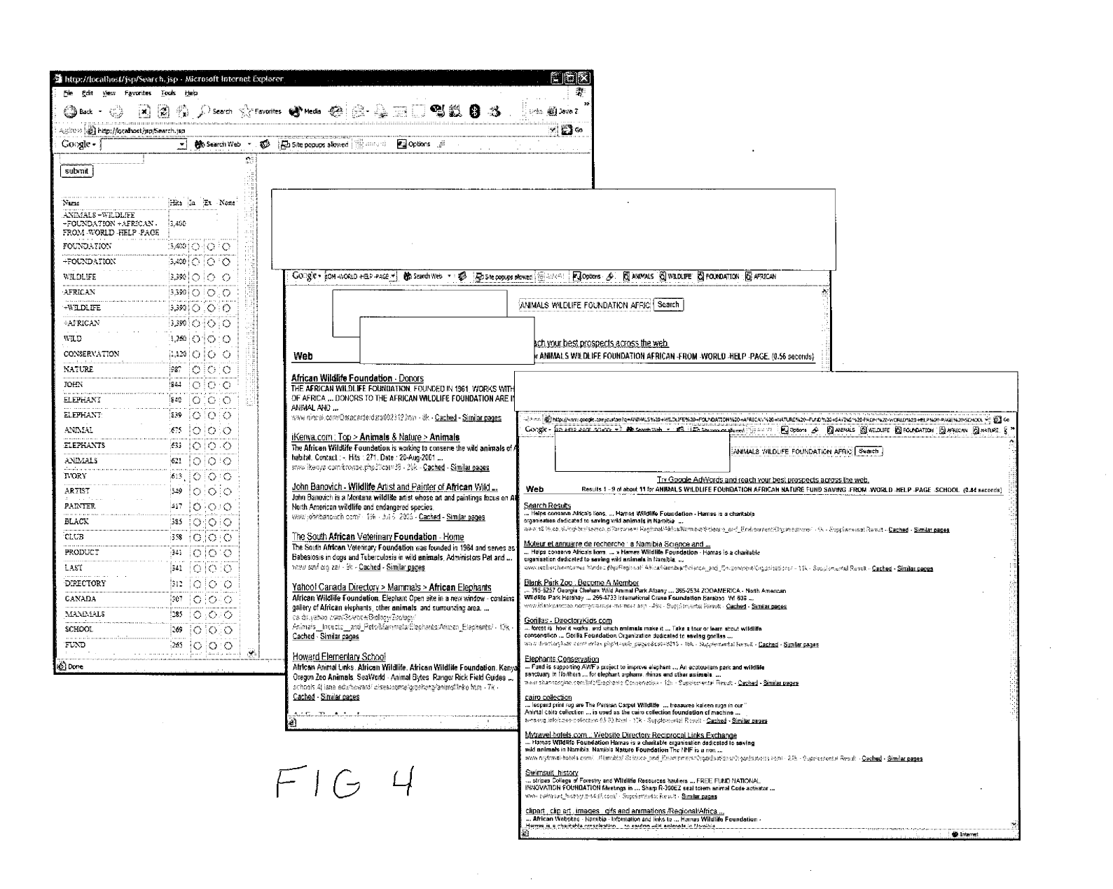

The final step reduces the search count to 11 items when using the searched-words ANIMALS+FOUNDATION+WILDLIFE+AFRICAN+NATURE+FUND+SAVING-FROM-WORLD-HELP-PAGE. These recursive searches converged the search count from 74 million to 11 in just 4 steps, as illustrated in FIG. 4.

The foregoing description of embodiments of the present invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

What is claimed is:

1. A search engine system that searches the internet for an initial word or set of words, collectively referred to as the initial searched words, comprising:
using a first search engine to conduct a first search of the searched words;
using the results of the first search to create correlative words with a correlative word search engine;
displaying correlative words with the highest count or correlation first;
inserting a subset of the correlative words in the first search engine and reruning the search; and
repeating the step of inserting the subset until search results converge.

2. The system of claim 1, wherein the search converges faster if a word of high correlation is excluded or a word of low correlation is included.

3. The system of claim 1, further comprising:
extracting from the first search words from a title, header, or body of returned web pages that match the initial searched words.

4. The system of claim 3, further comprising:
using select and count routines to create a set of correlated words with count and/or a correlation ratio.

5. The system of claim 4, wherein search, select and count operations are performed simultaneously.

6. The system of claim 1, wherein similar search routines can be utilized.

7. The system of claim 1, wherein correlative phrases are created and used in place of the correlative words.

8. The system of claim 7, wherein key phrases are created and used
